(19) United States
(12) Patent Application Publication
(10) Pub. No.: US 2019/0233762 A1
(43) Pub. Date: Aug. 1, 2019

(54) MULTIUSE, HIGH-EFFICIENCY AND ENVIRONMENT-FRIENDLY CLEANING SOLUTION AND PREPARATION METHOD THEREFOR

(71) Applicant: Linkage Technology Switzerland SA, Geneve (CH)

(72) Inventors: Yibin Luo, Nanjing City (CN); Libin Sun, Nanjing City (CN); Su Yang, Nanjing City (CN); Xinhan Zhu, Nanjing City (CN)

(21) Appl. No.: 16/331,116

(22) PCT Filed: Sep. 4, 2017
(86) PCT No.: PCT/CN2017/100310

§ 371 Date: Mar. 6, 2019

(30) Foreign Application Priority Data
Sep. 8, 2016 (CN) 201610812642.0

(51) Int. Cl. C11D 1/825; C11D 3/37; C11D 1/72; C11D 3/20; C11D 3/22; C11D 3/36; C11D 3/34; C11D 1/74

(52) U.S. Cl. CPC C11D 1/825; C11D 3/3765; C11D 1/721; C11D 3/2079; C11D 3/2093; C11D 3/362; C11D 3/349; C11D 1/74; C11D 3/225

(57) ABSTRACT

A multiuse, high efficiency and environment-friendly cleaning solution and preparation method therefor, the cleaning solution comprising the following components: sodium polyacrylate, surface active agent and deionized water. The surface active agent comprises a combination of any two or more of alkyl-polyoxyethylene ether acetate, plant polyenoid phenol polyoxyethylene ether or laurinol polyoxyethylene ether. The cleaning solution has a wide range of cleaning uses, and may exhibit a good cleaning effect when applied in multiple fields.

### TECHNICAL FIELD

The invention belongs to the field of daily cleaning, and specifically relates to a multipurpose, highly effective and environmentally-friendly cleaning fluid and a preparation method thereof.

### BACKGROUND ART

At present, due to the different materials and mechanisms of cleaning, most daily cleaning agents sold commercially are cleaning agents with high specificity, such as special cleaning agents for glass, leather, floors and the like.

For Example, CN 201510495699.8 discloses a glass cleaning agent, in which the surfactant comprises anionic surfactant and nonionic surfactant in a mass ratio of 1:1 to 1:3. CN 201510503024.3 discloses a method for preparing a cleaning agent for glass curtain walls, and has sodium dodecyl benzene sulfonate, sodium methyl cocoyl taurate, sodium xylene sulfonate, and trisodium dicarboxymethyl alaninate in the formulation.

CN 201510718084.7 discloses a fast and powerful detergent for leather sofas that contains sodium bis ethylhexyl sulfosuccinate, which is an anionic surfactant. CN 201610287635.3 discloses a leather care cleaning agent that contains acetone, which is flammable and toxic and has a particular biting odor; ethyl acetate which has low toxicity; and ethanol which is irritative and harmful to the human body. However, the cleaning agent does not result in a shiny polished layer on the leather.

CN 201410699255.1 discloses a furniture cleaning agent which includes sodium silicate in the formulation. The sodium silicate liquid or mist is very irritating to the eyes and can cause conjunctival and corneal ulcers. Skin contact with the liquid can cause dermatitis or burns. The formulation contains ethylene glycol and ethylene glycol diethyl ether, and also contains alcohol which is irritating.

CN 201510773917.X discloses a powerful cleaning agent. The specification states that: “the cleaning agent has no side effects on cast iron, cast aluminium, leather, fabric, rubber, plastic, and the like.” The formulation contains sodium dodecylbenzene sulfonate, which is an anionic surfactant; there is content of sodium poly-oxyethylene nonylphenyl ether sulphate, which has low toxicity and is irritating to the skin.

CN 201510209702.5 discloses a non-scratching lustering, washing and cleaning agent, a preparation method and uses thereof. In the formulation, there are ammonium benzoate, which is highly toxic, and is irritating to the eyes, respiratory system and skin and has an ammonia odour or ammonium benzoate odour and gradually decomposes in the air, releasing ammonia; thiourea, which is decomposed by heat and releases oxides of sulfur and nitrogen and the like which are toxic gases harmful to health; and sodium dodecyl sulfate, sodium dodecylbenzene sulfonate, and sodium lignosulfonate, all of which are anionic surfactants.

The majority of the many kinds of daily cleaning agents (solutions) on the market currently contain large amounts of ionic surfactant, or use mixtures of ionic surfactant and nonionic surfactant. Because the ionic surfactants in the main have irritant and sensitization properties with respect to tissues such as the skin and eyes, it is difficult to guarantee safety and mildness.

Currently used daily cleaning agents usually contain nitrogen, phosphorus, ammonia, benzene and so on ions or groups. Although compounds containing these ions or groups in conventional daily cleaning products can achieve rapid and thorough cleaning effects, these compounds themselves have some environmentally harmful properties, and are likely to produce some polluting and damaging effects on both users and the environment where they are used, and after washing, the waste liquid which is directly discharged will pollute the environment. Therefore, how to develop a cleaning product for multiple purposes which is environmentally protective and pollution-free and does not contain nitrogen, phosphorus, ammonia, and benzene and so on ions or groups, and which has a performance that can reach or exceed that of the commonly used cleaning liquids containing the above harmful ions, and which simultaneously has more maintenance functions, is a big hot spot in current research.

### SUMMARY OF THE INVENTION

The object of the present invention is to provide a multipurpose, highly effective and environmentally-friendly cleaning fluid and a preparation method thereof in order to overcome the defects of the prior art. The multipurpose, highly effective and environmentally-friendly cleaning fluid is directly used in the cleaning process without requiring the additional use of water. A fiber towel or a special non-woven towel is used to absorb the appropriate amount of cleaning fluid to evenly wipe clean the surface of the object to be cleaned, and then the object is wiped dry with a hydrophilic towel, so that mixed dirt, such as greasy dirt, dust, and grit on the surface of the object can be quickly cleaned off to achieve the combined effect of thorough cleaning, lustering, and film coating in one step, while at the same time being unlikely to damage the surface of the object. The multipurpose, highly effective and environmentally-friendly cleaning fluid does not contain harmful components such as nitrogen, phosphorus, benzene and ammonia, the fluid is pH neutral, odourless and non-irritating, is harmless to the human body and does not pollute the environment. During use, the skin is protected and moisturized. The objects that can be cleaned primarily include various types of glass: such as high-rise and multi-layer glass curtain walls, and residential door and window glass; various types of metal: such as surfaces of stainless steel, aluminium, gold, silver, copper, alloys and the like; various types of paint and lacquer surfaces: such as painted or lacquered metal, furniture or flooring; various types of leather: natural and artificial leather products, such as bags and boxes, sofas, tables and chairs and the like; ceramics: ceramic products, such as washbasins, bathtubs and the like; natural marble, artificial floors and countertops; plastic product surfaces; and rubber product surfaces. Aside from kitchen areas and articles heavily coated with oil and grease, the cleaning fluid is suitable for the cleaning of a variety of everyday articles and living environments.

The technical proposal of the present invention is as follows:

A multipurpose, highly effective and environmentally-friendly cleaning liquid, wherein said cleaning liquid comprises the following components: sodium polyacrylate, surfactant, and deionized water.

Further, said multipurpose, highly effective and environmentally-friendly cleaning fluid, wherein the surfactant may be a combination of any two or more of alkyl polyoxyethylene ether acetate, plant-based polyene phenol polyoxyethylene ether and polyoxyethylene lauryl alcohol ether.

Further, said multipurpose, highly effective and environmentally-friendly cleaning fluid, which also includes one or two of sodium stearate and ethylene glycol distearate.

Further, said multipurpose, highly effective and environmentally-friendly cleaning fluid which also comprises any one or several of soybean liquid lecithin, Kathon and sodium carboxymethyl cellulose.

A multipurpose, highly effective and environmentally-friendly cleaning fluid, wherein said multipurpose, highly effective and environmentally-friendly cleaning fluid comprises the following components in parts by weight:

0.2 to 0.4 parts of sodium polyacrylate, 97.9 to 99.0 parts of deionized water and surfactant: wherein the surfactant is selected from any two or three of 0.3 to 0.6 parts of alkyl polyoxyethylene ether ethyl acetate, 0.2 to 0.5 parts of plant-based polyene phenol polyoxyethylene ether and 0.3 to 0.6 parts of polyoxyethylene lauryl alcohol ether.

Further, the multipurpose, highly effective and environmentally-friendly cleaning fluid which also includes, in parts by weight, any one or two of 0.02 to 0.03 parts of ethylene glycol distearate and 0.1 to 0.5 parts of sodium stearate.

Further, said multipurpose, highly effective and environmentally-friendly cleaning fluid which also includes, in parts by weight, any one or several of, 0.3 to 0.5 parts by weight of sodium carboxymethyl cellulose, 0.05 to 0.08 parts by weight of soybean liquid lecithin and 0.1 to 0.2 parts by weight of Kathon.

The method for preparing the multipurpose, highly effective and environmentally-friendly cleaning fluid comprises the following steps:

Step 1: the components are weighed out in parts by weight;
Step 2: the sodium polyacrylate is added to 10 to 20 parts of deionized water, stirred at room temperature until completely dissolved, and the pH of the system adjusted to 7.0 to 7.2 to obtain a mixed solution 1;
Step 3: the surfactant is added to 5 to 10 parts of deionized water, the temperature raised to 70 to 80° C., stirring and dissolution performed followed by cooling to room temperature, and the pH of the system adjusted to 7.0 to 7.2 to obtain a mixed solution 2;
Step 4: the mixed solution 2 is added to the mixed solution 1, then the balance of the water is added, the pH of the system adjusted to 7.0 to 7.2, and stirring and homogeneous mixing performed to obtain the multipurpose, highly effective and environmentally-friendly cleaning fluid.

Further, according to the method for preparing the multipurpose highly effective environmentally-friendly cleaning fluid, the regulating agent used for adjusting the pH of the system is acetic acid or citric acid.

Further, said method for preparing the multipurpose, highly effective and environmentally-friendly cleaning fluid, wherein 0.3 to 0.5 parts by weight of sodium carboxymethyl cellulose is added in step 2, and/or one or two of 0.02 to 0.03 parts by weight of ethylene glycol distearate and 0.05 to 0.08 parts by weight of soybean liquid lecithin is added in step 3, and/or one or two of 0.1 to 0.2 parts by weight of Kathon and 0.1 to 0.5 parts by weight of sodium stearate is added in step 4.

Sodium polyacrylate as a builder is an ideal material for manufacturing a non-toxic and non-polluting washing agent. Sodium polyacrylate is a novel highly effective environmentally-friendly detergent builder that can replace tripolyphosphate and other aluminium salts commonly used in the current washing agents, thereby eliminating the environmental pollution caused by the sodium tripolyphosphate and aluminium salts discharged in the waste water. The performance of the sodium polyacrylate builder is far superior to that of the conventional sodium tripolyphosphate: the washing effect is equivalent to 5 times that of the same weight of sodium tripolyphosphate, and even if the amount used is only ⅕ of that of sodium tripolyphosphate, the costs of the washing agent can be reduced. The mechanism of action of sodium polyacrylate as the builder is as follows: sodium polyacrylate has a chelating action on metal ions and acts as an alkaline buffer; sodium acrylate also has a good coagulating effect on colloidal suspensions due to its property of neutralizing the surface charges, in other words forming ionic bonds with the positively charged suspended particles, while at the same time, electrostatic repulsion due to the carboxyl groups of the sodium polyacrylate results in a localized stretching out of the flexible polymer, facilitating adhesion and aggregation of suspended particles and the formation of crosslinks between the particles. When there are Na⁺ ions and Ca²⁺ ions around the polymer, then it is the Ca²⁺ ions that are more easily adsorbed and fixed. As the adsorption by the multi-molecular system progresses, the surface charge reverses and the hydrophilicity increases, causing a gel protecting action and resulting in the stabilization of the particle dispersion system. Sodium polyacrylate is a highly effective detergent builder that causes dirt to detach from the surface of the body of a vehicle and prevents dirt from being re-deposited on the surface of the vehicle body.

Sodium polyacrylate has good emulsion and dispersion stability, is heat resistant, has good mechanical stability, can block trace metal ions, and is non-toxic, and can improve the lubricity and stability of the cleaning fluid.

Sodium carboxymethyl cellulose forms an homogeneous emulsion with stable properties. Because of its safety and reliability, carboxymethyl cellulose is recognized as a safe additive and in the National Food Hygiene Standard ADI, the amount which can be used is not limited: carboxymethyl cellulose has a role in flocculation, chelation and emulsification, and increases the cleaning fluid lubricity, facilitating wiping clean with the cleaning fluid and saving time and labour.

The surfactants employed in this invention are entirely nonionic. Two or more of alkyl polyoxyethylene ether acetate, plant-based polyene phenol polyoxyethylene ether and polyoxyethylene lauryl alcohol ether, for use in washing, are blended. By utilizing the compatibility of the above-mentioned surfactants, the concentration of the surfactants in the cleaning fluid can be reduced to 0.1 to 0.3%, thereby reducing the cost, reducing the surface tension of the solution, and increasing the wettability; overcoming the primary problems of irritancy and sensitization that ionic surfactants create with tissues such as skin and eyes, ensuring the safety and mildness of the cleaning fluid in use, while not damaging the human body and protecting the skin. Alkyl polyoxyethylene ether acetates have good biodegradability, a mild effect on the skin, afford less enzyme interference, and have good resistance to hard water and detergency. Polyoxyethylene lauryl alcohol ether has excellent washing, emulsifying, dispersing, wetting and solubilizing functions and the like, and has strong foaming power, ready rinsing and excellent detergency properties; and is one of the least irritating surfactants to the skin. Polyoxyethylene lauryl alcohol ether can be compounded with a variety of surfactants to reduce the irritancy thereof and improve the performance of the product. Wherein, the plant-based polyene phenol polyoxyethylene ethers mentioned above which are preferably used, are produced by Nasurfar BioMaterial Technology (Changshu) Co. Ltd., Jiangsu Province, China, and were sold on the market prior to the filing of the application as the plant-based polyene phenol polyoxyethylene ether type NSF 10E, whose main components come from natural plants and have excellent biodegradability. This material has highly effective cleansing properties: a strong ability to remove animal and vegetable fats and oils, and a good ability to wash off machine oil and mineral oil. This material emulsifies in water, is low foaming and has good compatibility with other surfactants.

Ethylene glycol distearate has good compatibility with the surfactants provided by the present invention, and heated in the above-mentioned surfactant mixture forms a pearlescent paste that can embody a stable pearlescent effect wherein the pearlescent effect produced is exquisite; so that after being used to clean a vehicle body, the lacquer/paint surface optical effect is better. Ethylene glycol distearate does not irritate the skin, but moisturizes the skin and also has an antistatic effect and prevents dust from adhering.

Sodium stearate has good water solubility, so that in use, wiping clean is more easily facilitated than with the traditional silicone oil and palm wax; after use, a smooth, bright and durable protective film can quickly form on the vehicle paint/lacquer; while at the same time, the sodium stearate has a skin moisturizing effect.

Soybean liquid lecithin has good emulsifying ability and protects the skin.

Kathon is an internationally recognized preservative for daily chemicals which is safe, highly effective and broad-spectrum, with bactericidal and bacteriostatic effects, and affords the cleaning fluid with increased stability and a prolonged expiry date.

In the cleaning process with the multipurpose, highly effective and environmentally-friendly cleaning fluid provided by the present invention, the sodium polyacrylate chelating action on the metal ions as well as the alkaline buffering conditions and coagulating action cause the general dirt, grease, dust and the like to combine more easily with the surfactants in the present invention, to accelerate efficient cleaning, while also make the difficult-to-clean dirt, grease and the like combine more easily with the surfactants in the present invention, to improve the degree of cleaning. During the cleaning process, the sodium stearate will form a uniform protective film on the surface of the cleaned object, and the ethylene glycol distearate acts synergistically with the sodium stearate in the protective film to form a brighter layer, which improves the surface brightness of the cleaned object, and simultaneously enhances the stability of the protective film. The surfactant used in the present invention can enhance the lustering properties of the ethylene glycol distearate, thereby further enhancing the lustering effect. The ethylene glycol distearate used in the present invention acts as a lustering agent, and during use not only can cooperate synergistically with the sodium stearate to construct a protective film, but also affords superiority in terms of ease of wiping clean and ease of dispersion, and can easily be evenly rubbed on the object being clean to form a glazing layer. The sodium carboxymethyl cellulose and the sodium polyacrylate in the cleaning fluid of this invention mutually interact to enhance lubricity, so that the cleaning process is more easily conducted.

The multipurpose, highly effective and environmentally-friendly cleaning fluid provided by the present invention is easy to use, and only a fiber towel soaked with the cleaning fluid of the present invention needs to be used to wipe the dirt of the surface off the object being cleaned, and after wiping clean, a clean, water absorbent towel is used to wipe the surface of the object dry, thereby achieving an integrated effect of thorough cleaning, film coating and lustering.

The cleaning fluid provided by the present invention does not contain harmful components such as nitrogen, phosphorus, benzene and ammonia, and does not pollute the environment.

The cleaning fluid provided by the present invention is directly used in the process of cleaning an object, and does not need to be diluted by the addition of water, thereby conserving substantial water resources.

In the cleaning fluid provided by the present invention, the use of nonionic surfactants improves the mildness of the cleaning fluid, thereby effectively reducing irritancy. The surface tension of the solution is reduced and the wettability is increased. At the same time, the amount used is small and the costs are low.

In the cleaning fluid provided by the present invention, the ethylene glycol distearate and the nonionic surfactants used in combination can produce a distinct pearlescent effect, and also have skin emollient and antistatic effects.

The cleaning fluid provided by the present invention makes wiping clean easier, and after use can rapidly form a uniformly smooth, bright and durable protective film on the surface of vehicle paint/lacquer. After use, the paint/lacquer film does not cause discoloration, blistering or peeling, there is no loss of lustre and no difference in colour.

### DETAILED DESCRIPTION OF PREFERRED EMBODIMENTS

The formulation composition in the following Example 1 to Example 7 is as follows:

### 1. Formulation Composition

Raw material ratio (mass ratio) calculated to give 1000 grams

| Raw materials | Example 1 | Example 2 | Example 3 | Example 4 | Example 5 | Example 6 | Example 7 |
|---|---|---|---|---|---|---|---|
| Sodium polyacrylate | 2 | 2 | 2.5 | 2 | 3.5 | 4 | 4 |
| Sodium carboxymethyl | | | 4 | 3 | 5 | | |
| cellulose | | | | | | | |
| Alkyl polyoxyethylene | 3 | 6 | 5 | 3 | | 4 | 6 |
| ether acetate | | | | | | | |
| Plant-based polyene | 2 | 3 | | 2 | 5 | 4 | 5 |
| phenol | | | | | | | |
| polyoxyethylene ether | | | | | | | |
| Polyoxyethylene lauryl | 3 | 3 | 5 | 3 | 4 | 6 | 6 |
| alcohol ether | | | | | | | |
| Soybean liquid lecithin | | | 0.8 | 0.5 | 0.5 | | |
| Ethylene glycol distearate | | 0.2 | 0.2 | 0.3 | 0.3 | 0.2 | |
| Sodium stearate | | 2 | 3 | 1 | 4 | 5 | |
| Kathon | | | 1.5 | 2 | 1.5 | 1 | |
| Deionized water | 990 | 983.8 | 978.0 | 983.2 | 976.2 | 975.8 | 979 |

The preparation method in the above-mentioned Example 1 to Example 7 is as follows:

Step 1: each component was weighed out;
Step 2: the sodium polyacrylate was added to 10 to 20 parts of deionized water, stirring at room temperature performed until complete dissolution occurred, and the pH of the system adjusted to 7.0 to 7.2 to obtain a mixed solution 1;
Step 3: the alkyl polyoxyethylene ether acetate, plant-based polyene phenol polyoxyethylene ether, and polyoxyethylene lauryl alcohol ether were added to 5 to 10 parts of deionized water, the temperature raised to 70 to 80° C., stirring performed until complete dissolution occurred, followed by cooling to room temperature, and the pH of the system adjusted to 7.0 to 7.2 to obtain a mixed solution 2;
Step 4: the mixed solution 2 was added to the mixed solution 1, the balance of the water was added, the pH of the system adjusted to 7.0 to 7.2, and stirring and mixing to uniformity performed to obtain the multipurpose, highly effective and environmentally-friendly cleaning fluid.

In the above-mentioned Example 1 to Example 7, sodium carboxymethyl cellulose, ethylene glycol distearate, soybean liquid lecithin, sodium stearate and Kathon are involved in the formulation. In the specific preparation processes, the sodium carboxymethyl cellulose is added in step 2, the soybean liquid lecithin and/or ethylene glycol distearate is added in step 3, and the sodium stearate and/or Kathon is added in step 4. The regulating agent used for adjusting the pH of the system in the above-mentioned preparation method was acetic acid or citric acid.

The multipurpose, highly effective and environmentally-friendly cleaning fluids prepared in the above-mentioned Examples 1 to 7 were tested by the National Processed Food and Food Additive Quality Inspection Center (Nanjing) at the Nanjing Institute of Product Quality Inspection, with reference to the standard GB 9985-2000 “Detergents for hand dishwashing”. The test conclusions were that the total content of active substances was more than 16%, the pH (25° C., 1% solution) was 7.0 to 7.2, no formaldehyde was detected, and the detergencies of all the fluids were greater than those of standard dish washing detergents.

In accordance with the tests for the criteria of HJ636-2012 and GB11893-89, the amounts of ammonia nitrogen contained were zero according to the HJ636-2012 test, and the amounts of phosphorus contained were zero according to the GB11893-89 test.

An acrylic paint/lacquer film test plate was immersed in the cleaning fluid and soaked for 2 days. The test result was as follows: the paint/lacquer film showed no discoloration, blistering, or peeling, no loss of lustre, and no difference in colour.

A series of performance comparison and verification tests were carried out during the research and development process of the invention; and in order to further illustrate the performance effect of the multipurpose, highly effective and environmentally-friendly cleaning fluid provided by the present invention, several typical examples of these have been selected and are illustrated below:

The vehicle cleaning performance of the cleaning fluid prepared in Example 4 of the present invention and of a product obtained from the domestic application patent of application No 201510209702. 5 were compared. The details were as follows:

| | Example 4 of | |
|---|---|---|
| Test details | the present invention | 201510209702.5 |
| Cleaning intensity | 96% | 80% |
| Bright film effect | Good | General |
| Trace residues | None | There were residual |
| | | traces, and there were |
| | | white residues which |
| | | were obvious, |
| | | particularly so in |
| | | the case of black cars |
| Feel of the hands | Clean and smooth | Rough |
| after use | | |
| Odour | No odour and no irritancy | Irritating odour |
| Bacteriostatic effect | Food grade sterilization | Yes |
| Harm to the human | Harmless | Harmful |
| body | | |

The leather bag cleaning performances of the cleaning fluid prepared in Example 4 of the present invention and a product obtained from the domestic application patent of application No 201610287635.3 were compared. The details were as follows:

| | Example 4 of the present | |
|---|---|---|
| Test details | invention | 201610287635.3 |
| Cleaning intensity | 98% | 85% |
| Brightening effect | Good | No |
| Pearlescent film effect | Uniform film, bright | No |
| Trace residues | No | Yes |
| Feel of the hands after | Clean and smooth | Rough |
| use | | |
| Odour | No odour and no irritancy | Irritating odour |
| Bacteriostatic effect | Food grade sterilization | Yes |
| Harm to the human body | Harmless | Harmful |

The furniture cleaning performances of the cleaning fluid prepared in Example 4 in the present invention and a product obtained by the domestic application patent of application No 201410699255.1 were compared. The details were as follows:

| | Example 4 of the present | |
|---|---|---|
| Test details | invention | 201610287635.3 |
| Cleaning intensity | 98% | 80% |
| Brightening effect | Good | No |
| Pearlescent film effect | Uniform coating film, | No |
| | bright | |
| Trace residues | No | Yes |
| Feel of the hands after use | Clean and smooth | Rough |
| Odour | No odour and no | Irritating odour |
| | irritancy | |
| Bacteriostatic effect | Food grade sterilization | Yes |
| Harm to the human body | Harmless | Harmful |

The inventors carried out a series of performance comparison tests on the multipurpose, highly effective and environmentally-friendly cleaning fluid provided by the present invention during the development process, and several Examples were selected and are described below:

### Test 1

Sodium dioctyl sulfosuccinate, sucrose ester, alkyl phenol polyoxyethyl ether, fatty alcohol polyoxyethylene ether, sodium diisobutyl sulfosuccinate, sodium dodecyl benzene sulfonate, and ammonium nonylphenyl polyoxyethylene ether sulfate were used as surfactants instead of the surfactants in the present invention. Vehicle cleaning fluids were prepared by adding two or three of the above surfactants to the formulation instead of the surfactants in Example 1 of the present invention, and were used for cleaning the surface of a vehicle. The test results show that the speed and thoroughness of dirt removal of these cleaning fluids were lower than the speed and thoroughness of dirt removal of the cleaning fluid in Example 1. At the same time, on removing the sodium polyacrylate component from Example 1, the performance of the prepared cleaning fluid was significantly lower than the performance of the cleaning fluids obtained in Example 1. The explanation is that the surfactants provided in the present invention and the sodium polyacrylate mutually achieve a synergistic effect, together improving the cleaning performance. The research of the present invention shows that in the cleaning process, the sodium polyacrylate can provide alkaline buffering conditions and at the same time can chelate the metal ions in the dirt, providing a coagulation effect, so that general dirt, grease, dust and the like combine more easily with the surfactants provided in the present invention, which efficiently accelerates the cleaning, and at the same time, make difficult-to-clean dirt and grease and the like combine more easily with the surfactants in the present invention, which improves the cleaning efficiency. Further studies have found that the surfactants in the cleaning fluid of the present invention not only act to remove dirt rapidly, but also enhance the lustering effect of ethylene glycol distearate.

### Test 2

After cleaning an object using the cleaning fluid prepared with a formulation of the present invention, but with no addition of sodium stearate, some lustrous effect formed on the surface of the object, but the degree of lustre was poor. On wiping using only little effort, it was clearly to be seen that the lustre had been destroyed; while after the surface of the cleaned object had been left to dry naturally, the lustrous layer on the surface was easily dirtied, indicating that the lustre stability was not good. Following the addition of sodium stearate however, a dense protective film was left on the surface of the object after cleaning and the stability of the film was very good, moreover the stability of the film after wiping dry was very good, and the film did not readily become dirty. The explanation is that both the sodium stearate and the ethylene glycol distearate used in the present invention can have a synergistic effect in the cleaning fluid system provided by the present invention to achieve better coating film lustre effects.

1. A multipurpose, highly effective and environmentally-friendly cleaning fluid, characterized in that the cleaning fluid comprises the following components: sodium polyacrylate, surfactant and deionized water.

2. The multipurpose, highly effective and environmentally-friendly cleaning fluid according to claim 1, characterized in that the surfactant is a combination of any two or more of alkyl polyoxyethylene ether acetate, plant-based polyene phenol polyoxyethylene ether and polyoxyethylene lauryl alcohol ether.

3. The multipurpose, highly effective and environmentally-friendly cleaning fluid according to claim 1, which is characterized by further comprising one or both of sodium stearate and ethylene glycol distearate.

4. The multipurpose, highly effective and environmentally-friendly cleaning fluid according to claim 1, characterized by further comprising any one or more of soybean liquid lecithin, Kathon and sodium carboxymethyl cellulose.

5. A multipurpose, highly effective and environmentally-friendly cleaning fluid, which is characterized in that the cleaning fluid comprises the following components in parts by weight:
0.2 to 0.4 parts of sodium polyacrylate, 97.9 to 99.0 parts of deionized water, and surfactant, wherein the surfactant is any two or three selected from the group consisting of by weight, 0.3 to 0.6 parts of alkyl polyoxyethylene ether acetate, 0.2 to 0.5 parts of plant-based polyene phenol polyoxyethylene ether and 0.3 to 0.6 parts of polyoxyethylene lauryl alcohol ether,

6. The multipurpose, highly effective and environmentally-friendly cleaning fluid in accordance with claim 5, characterized by further comprising one or both of 0.02 to 0.03 parts by weight of ethylene glycol distearate and 0.1 to 0.5 parts by weight of sodium stearate,

7. The multipurpose, highly effective and environmentally-friendly cleaning fluid according to claim 5 characterized by also comprising any one or several of 0.3 to 0.5 parts by weight of sodium carboxymethyl cellulose, 0.05 to 0.08 parts by weight of soybean liquid lecithin and 0.1 to 0.2 parts by weight of Kathon.

8. A method for preparing a multipurpose, highly effective and environmentally-friendly cleaning fluid according to claim 5, characterized by comprising the following steps:
Step 1: a step wherein each component is weighed out in parts by weight;
Step 2: a step wherein the sodium polyacrylate is added to 10 to 20 parts of deionized water, stirred at room temperature until completely dissolved, and the pH of the system adjusted to 7.0 to 7.2 to obtain a mixed solution 1;
Step 3: a step wherein the surfactant is added to 5 to 10 parts of deionized water, the temperature is raised to 70 to 80° C., stirring and dissolution performed, followed by cooling to room temperature, and the pH of the system adjusted to 7.0 to 7.2 to obtain a mixed solution 2;
Step 4: a step wherein the mixed solution 2 is added to the mixed solution 1, and thereafter the balance of the water is added, the pH of the system is adjusted to 7.0 to 7.2, and stirring and mixing to uniformity performed to obtain the multipurpose, highly effective and environmentally-friendly cleaning fluid.

9. A method for preparing a multipurpose, highly effective and environmentally-friendly cleaning fluid according to claim 8, characterized in that the agent for adjusting the pH of the system is acetic acid or citric acid.

10. A method for preparing a multipurpose, highly effective and environmentally-friendly cleaning fluid according to claim 8, characterized in that in step 2, 0.3 to 0.5 parts by weight of sodium carboxymethyl cellulose is added, and/or in step 3, one or both of 0.02 to 0.03 parts by weight of ethylene glycol distearate and 0.05 to 0.08 parts by weight of soybean liquid lecithin is added, and/or in step 4, one or both of 0.1 to 0.2 parts by weight of Kathon and 0.1 to 0.5 parts by weight of sodium stearate is added.
